(19) United States
(12) Patent Application Publication
(10) Pub. No.: US 2022/0137988 A1
(43) Pub. Date: May 5, 2022

(54) VIRTUALIZATION FOR WEB-BASED APPLICATION WORKLOADS

(71) Applicant: Hewlett-Packard Development Company, L.P., Spring, TX (US)

(72) Inventor: Christoph Graham, Spring, TX (US)

(73) Assignee: Hewlett-Packard Development Company, L.P., Spring, TX (US)

(21) Appl. No.: 17/419,053

(22) PCT Filed: Jul. 11, 2019
(86) PCT No.: PCT/US2019/041446

§ 371 Date: Jun. 28, 2021

(51) Int. Cl. G06F 9/445; G06F 9/48

(52) U.S. Cl. CPC G06F 9/44521; G06F 9/4881

(57) ABSTRACT

Virtualized web-based application workloads include web-based application requests from clients that are intercepted. The type of request is determined and results for the requested web-based application are replaced with redirected output using application code that is separate from the client.

### BACKGROUND

Two types of remote applications exist in the cloud. The first type includes remote applications that were originally created on a desktop infrastructure but which are now remoted as a virtual desktop. The second type includes web-based applications that first came to existence within the cloud, such as Software as a service (SAAS) software and services. The web-based applications in the cloud have become commonplace and many companies now provide a virtualization model that does not require a physical device for data to be stored. Web-based application workloads are expanding in presence and general use, thus displacing traditional compiled application technologies.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is a computing environment for implementation according to an example of the principles described herein.

FIG. 2 is a computing environment for implementation according to an example of the principles described herein.

FIG. 3 is a computing environment according to an example of the principles described herein.

FIG. 4 is a flowchart illustrating an exemplary method of providing a virtual web-based application workload according to an example of the principles described herein.

FIG. 5 is a flowchart illustrating an exemplary method of providing a virtual web-based application workload according to an example of the principles described herein.

FIG. 6 is a computer readable storage medium for providing a virtual web-based application workload according to an example of the principles described herein.

FIG. 7 is a system for providing a virtual web-based application workload according to an example of the principles described herein.

### DETAILED DESCRIPTION

In the following description, for purposes of explanation, specific details are set forth in order to provide a thorough understanding of the disclosure. It will be apparent, however, to one skilled in the art that examples consistent with the present disclosure may be practiced without these specific details. Reference in the specification to “an implementation,” “an example” or similar language means that a particular feature, structure, or characteristic described in connection with the implementation or example is included in at least that one implementation, but not necessarily in other implementations. The various instances of the phrase “in one implementation” or similar phrases in various places in the specification are not necessarily all referring to the same implementation.

The preceding description is presented only to illustrate and describe examples of the principles described. This description is not intended to be exhaustive or to limit these principles to any precise form disclosed. Many modifications and variations are possible in light of the teaching herein.

A “web-based application,” as used herein, is any program that is accessed over a network connection using HTTP, rather than existing within a device's memory. Web-based applications often run inside a web browser.

A “web application” may also be applicable to principles described herein and is defined as a software application that runs on a remote server. In most cases, web browsers are used to access web applications, over a network, such as the Internet. Some web applications are used in intranets, in companies, and schools, for example.

As web-based application workloads become more and more commonplace, a major concern today is web-based application security attacks that target a client. Such attacks can take the form of a malicious attack on a web browser or web-based application code that runs on the client. In other words, while web-based applications pose a new development paradigm, they are inherently vulnerable to side-effects and security weaknesses imposed by execution of application code on the client, albeit within the context of a web browser. As end-users become more dependent on web-based applications, new mechanisms will be required to secure content, preserve compatibility, and ensure configuration of web-based applications outside the control of the client web browser.

Existing capabilities do not provide an effective solution. For example, virtualized desktops and virtualized applications provide remote access to applications hosted within the context of a virtual host operating system and provide access to such applications through a custom remote redirection protocol. However, these virtualized desktops and applications require a host operating system that understands and translates virtualized actions within the context of the operating system and its application layer. This creates significant overhead to remote applications but virtualized systems were designed for the remoting of instruction sets and desktops.

In other examples, one operating system remotes another operating system. However, these examples are also designed for the concept of rendering one or more software applications over a network-based protocol. Operating systems simply do not support the idea of multiple applications being served to multiple users simultaneously, and no efficiencies to the model exist for the concept of virtualizing the same application container, or in other words, the same browser application. In addition, these solutions require the remoting operating system's client to connect to and interoperate with the server applications which makes the system vulnerable to attacks.

Sandboxing is one example of a management strategy that isolates applications from critical system resources and other programs. It provides a layer that is either built into modern web browser designs, and/or implemented by client-side virtualization products to segment web-application code from other web-based applications, including other web-based applications, in an attempt to isolate any malicious behaviors from one application leaking into or exposing data in another application. There are still security issues, however, with malicious activity that can get down to the hardware level. For example, side channeling can occur within a browser where one application introspects another application without having any kind of privilege.

The present specification presents a servicing model to virtualize web-based applications outside the context of the client by creating an additional layer of security and imposing requirements on the configuration of the web-based applications that cannot be compromised by misconfiguration or malicious code within the client device context.

An example method according to principles described herein for virtualizing web-based application workloads includes intercepting a request for a web-based application from a client. The type of request for the web-based application is determined. Results for the requested web-based application are replaced with redirected output using application code that is separate from the client. An example system according to principles described herein for providing virtualized web-based application workloads includes a non-transitory memory that stores instructions and a computer processor that executes the instructions to perform operations. Such operations include the interception of a request for a web-based application from a client. Operations replace results for the web-based application with a corresponding redirected output from a virtualized browser that application code that is separate from the client.

An example non-transitory computer readable medium according to principles discussed herein includes usable program code to, when executed by a processor, intercept a request for a web-based application from a client. The processor further redirects the request to a specific application access point maintained by a web generator. Output from an appropriate virtualized browser at the specific access point replaces results for the web-based application by using application code that is separate from the client.

The systems and methods described herein allow web-based applications to be attached either seamlessly by interception of web content requests and replacing results with redirected output, or to web-based applications by use of specific application access points which provide entry to web-based applications over a network. To that end, the solution may include a virtual web generator service that maintains the application access points to web-based applications that are proxied before interception with the client end-point device.

These systems and methods allow for shared resources and efficiencies of a web-application framework, such as a rendering engine, JavaScript runtime, networking libraries and other resources where contents of web-based applications are rendered and executed within the context of the web-application proxy. “Efficiencies” are a measure of performance and resources expended for content caching per web-based applications or content caching across web-based applications (such as shared libraries). Examples include network efficiencies in managing connectivity with application providers or end-point devices. Further examples include session and state management efficiencies for environments where customers may disconnect/reconnect frequently from the web-based applications.

Instead of traditional type of content that would normally follow a request for a web-based application, a different type of content is received. This may include a visually-based representation of the web-based application that is provided by a translating protocol. The translating protocol replaces code that would otherwise run on a client based on the request being made. For example, typical HTML content may be replaced with WebRTC, an open protocol for the redirection of remote content that is supported directly by a wide range of browsers today, or through JavaScript extension libraries. With an open protocol such as WebRTC, web browser environment and configuration characteristics can be highly regulated per application per user and/or per device to achieve the desired end-user experience and maintain the appropriate controls for IT and application governance. Variations include that the content be altered itself rather than or in addition to, the type of content.

In addition, such a solution allows for the specification of extended web resources, such as add-on behaviors and web-browser plugin capabilities to be configured and prescribed at a whole user population level irrespective of browser client or operating system that may exist on the user's endpoint device. And finally, such a solution ensures that the correct application behaviors are maintained by specification of the web browser and its various subcomponents.

Also, security is maintained by the tight control of the configuration of the redirecting browser environment and the fact that direct data and content are not being redirected in a translatable form to the client. In addition, no application code is running on the client, thus eliminating deviations in client behavior by the introduction of misconfigurations or unintended code execution.

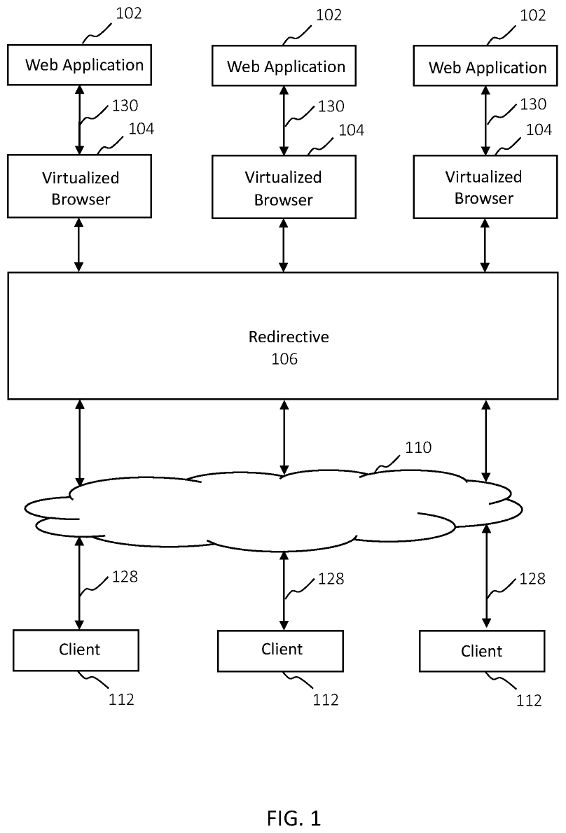

Turning to FIG. 1, a computing environment is shown for implementing principles described herein. Requests for web-based applications 102 by clients 112 over the network 110 are intercepted by a redirective 106. The redirective 106 determines a type of request for the requested web-based applications 102 with redirected output. Application code not running on the clients is used to maintain security. The redirected output includes virtualized browsers 104 of the web-based applications 102 or content thereof.

The redirective 106 acts to intercept the request and determine the type of request being made. The type of request may be any kind of request, such as a request for one of more web-based applications, information retrieval, email or other communication, data sync or update, collaboration tool, etc. The request may include the location of the resource, data or content, such as a representative of a URI (Universal Resource Identifier), security credentials such as certificates session keys or authorization tokens, and data such as parameters required for access to specific application programming interfaces (APIs) maintained by the remote resource.

The type of request may further correspond to certain web-based applications or certain virtualized and proxied browsers and be used to process the redirected output. A determination of the type of request may be accomplished by resolution of network location and resource location (such as in a URI [Universal Resource Identifier]) of resources being accessed by the client endpoint device.

The redirective 106 acts to respond to the request with redirected output from an appropriate virtualized and proxied browser 104. An “appropriate” virtualized browse as used herein describes a virtualized browser that delivers meaningful or related content that is responsive and relevant to the request. The virtualized browser 104 recreates the requested web browser to deliver redirected output that may include output that is the same or similar to content of the requested web-based application.

The redirected output may be visible to a user through a screen sharing method in a virtualized browser 104. For example, the output of the virtualized and proxied browser 104 may include one or more of a visual image and sound reproduction. Contents that would normally be executed at the client in a non-virtualized usage, such as metrics and advertisement tracking telemetry, may instead be executed at the virtualized browser 104.

The redirected output may include all of the content requested. Alternatively, policies may augment or filter content to remove items as part of the virtualized browser rendering (such as advertisements, or links to external and unsecure resources). Also, content may be added to the end point client stream or redirected output along with the WebRTC protocol (e.g., watermarking, DRM execution code, access to security tokens or other end user authentication instructions that must be run on the client 112).

Input from the user may also be determined such that the redirective 106 intercepts the input and replicates it, or otherwise redirects it, to the virtualized and proxied browser 104 as virtual input. For example, mouse and keyboard input from the client 112 may be redirected to the virtualized browser 104 as virtual input. As a specific example, a user may send a request to access health care information and make a request for a prescription. The request is then intercepted and the results from the site are replaced with virtual results instead. The overall experience may essentially be one of sharing a screen like that used for collaboration tools and online social hangouts.

The redirective 106 can be an intermediary server on the client 112 or an intermediary device, engine, or system, with a different version of html content than that of the web-based application requested. The redirective 106 may include application code that runs on a different server than one on the client 112, or other computational device. The redirective 106 may include application code that runs on a dedicated computer that responds to the requests of one or more clients 112 and has data processing capability. The connection established between the client 112 and redirective 106 and the network 110 may include wired, wireless, optical or any other type of connection that allows communication. The web-based application 102 requested may be any computer-based software application or webpage that may be hosted by a web server and accessed by client 112 view computer network 110, such as the Internet.

Note that an act of interception may be done transparently or visibly to one or more of the user and client 112. Furthermore, the entire communication can be performed without making any changes to the web-based application requested, the client, or subcomponents thereof.

The client 112 may be a computing device such as a wireless telephone, desktop computer, laptop, tablet, personal digital assistant (PDA), watch, headset, thread or process running on a device, and/or an object executable by a device. Client 112 may include a client software, such as a web browser like Firefox, Chrome, Internet Explorer, Safari, etc. In an example, a user of client 112 using a web browser sends a request for a web-based application (e.g., by URL, link within an email, link with a web page, etc.) to a known server. The communication may be established using an Internet Protocol, for example, a hypertext transfer protocol (HTTP)/hypertext transfer protocol secure (HTTPS) 130, TCP-based or UDP-based protocol appropriate for data transfer of web content, etc. The solution provides equalization of web-based applications experience across various client environments.

Instead of a traditional response to the request that includes HTML content from a web-based application 102, users and clients 112 are presented with content through a connection 128, such as Web-RTC 128, a visual display protocol that is built into modern web browsers. The content may also come from another open protocol for the redirection of remote content that is supported directly by a wide range of browsers today or through JavaScript extension libraries.

The content may include visual content from a virtualized browser 104 containing a proxied web-based application of the web-based application 102 requested. One of the benefits to only providing visual information is the security provided to the client 112 with the isolation of data. For example, data is not on the client 112, and instead the user is limited to viewing a screen that is not translatable, or not easily translatable (e.g., requiring special knowledge privilege, and access, etc.), into raw characters and words that can be parsed, searched, indexed, or otherwise be interpreted by machine automation or a human.

As a specific example, a user may take a picture of a page of a word document, however the client does not have access to the entire word document. It is hosted in a different ecosystem. This provides security in keeping the word document from a user that should not have access to the client 112, malware on the device, a break in web connection, etc.

Many other advantages to virtualization of web-based applications may be realized. Not only is the data not visible, but the data is also not cached locally. For example, keys that are typed or paragraphs that are written are all remoted and erased as the user is going along. Typically key strokes or other type of data would ordinarily be seen inside a website with tools that are created to extract the data locally. For example, many of the tools useful for debugging by developers can read and examine memory of the browser process and extract such textual data (as paragraphs that are written, etc.), but since the virtualization is only serving the screen or other form of limited output, the content is not stored on the local level. This provides a high degree of security.

With web-based applications, data is downloaded from a web server and sits on the client and may be vulnerable to attack. For instance, a word document or other digital medium may sit on the client and be scrapable. The digital medium may be susceptible to parsing of contents to extract meaning by examination of the memory in which the medium is stored. The concept of capturing the image-based concept can further be enforced with DRM extensions to the WebRTC protocol. By providing another layer with a screen-like interface such as provided by the redirective 106, the visuals without the real data are presented. This can be done without the user knowing that the web-based application has been replicated and that content normally from sources such as Java and HTML through the context of a website has been replaced.

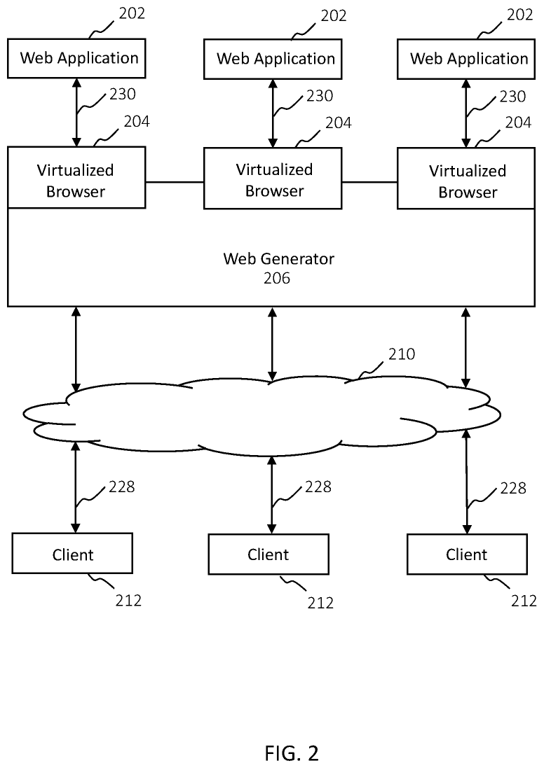

In some examples, instead of a redirective 106, a web generator may be used to provide virtualized browsers and web-based applications that are proxied before the interception of requests from clients. Turning to FIG. 2, a virtualized browser 204 and proxied web-based applications 202 are generated by a web generator 206.

A “web generator,” as used herein, is a service that acts to intercept a client request sent over a network and then replace the results with an appropriate virtualized browser that maintains correct application behaviors for the associated web-based application and various subcomponents of the web-based application. The web generator 206 shown in FIG. 2 acts to intercept a client request sent over a network 210 and then replace the results with an appropriate virtualized browser 204 that maintains correct application behaviors for the associated web-based application 202 and various subcomponents of the web-based application 202. Results for the web-based application request are replaced and sent to the client 212 over the network 210 with redirected output from the appropriate virtualized browser 204. Like the redirective, the results are sent using application code not running on the client in efforts to maintain security on the client 212. The act of intercepting may be done transparently or visibly to one or more of the user and client 112.

The communications described may be established using an Internet Protocol, for example, a hypertext transfer protocol (HTTP)/hypertext transfer protocol secure (HTTPS) 230, hypertext transfer protocol version 2 (HTTP2), etc. Users and clients are presented with content through a connection, such as Web-RTC 228, a visual display protocol that is built into modern web browsers. There is a seamless transformation with any browser that uses Web-RTC.

The web generator 206 and redirective 106 are middle layers between the user and the web-based applications 102 that allow for additional control gates. FIG. 2 shows the virtualized browsers 204 included with the web generator 206 to show that web-based applications 202 are being generated, hosted, or otherwise linked to the web generator 206. FIG. 1 on the other hand shows the virtualized browsers 202 being separate from the redirective 206 to indicate that the redirective 206 is an orchestration layer and the actual web-based applications 102 are hosted elsewhere. Virtualized browsers may be hosted independent of the redirective on different machines and the redirective points to them.

Virtual web browser environment and configuration characteristics can be highly regulated per application per user and per device to achieve a desired end user experience and maintain the appropriate controls for information technology (IT) people and application governance. For example, time limits of usage can be implemented and logins for restricted areas can be reinforced. Instead of using SAAS software or other monitoring software, acts of monitoring usage and performance can be monitored directly. A detailed visibility is provided into application workloads outside the scope of the client or any requirement for opt-in monitoring.

In addition, such a solution allows for the specification of extended web resources, such as add-on behaviors and web-browser plugin capabilities to be configured and prescribed at a whole user population level irrespective of browser client or operating system that may exist on the user's endpoint device. The entire web browser session is being redirected, so any activities applicable to the virtualized web browser may be redirected as well, such as browser configuration settings like font size, background color, scroll speed. In addition, many browsers support plug-in architectures where additional functionality can be integrated into a web page, such as password management, grammar and spelling checkers, data validators, translators, etc.

And finally, such a solution ensures that the correct application behaviors are maintained by specification of the web browser and its various subcomponents, such as a browser window manager, JavaScript runtime, security controls, additional services to configure and control the rendering of web content, a plug-in ecosystem that extends or enhances these behaviors, etc.

Other benefits can be realized from the present system and methods. For example, requirements for web-based applications may be simplified by offloading the computing requirements typically on the client. To execute on the client device may consume additional processing and execution time, or power consumption that it would on a virtualized browser. As a specific example, a virtualized browser infrastructure may contain optimized video decode processing that is not available on the client device.

There are also inherent power and performance efficiencies by leveraging the graphics processing unit (GPU) offload features to render the remoting protocol. For example, Web-RTC is a stream-based protocol comprising a visual representation of the remote content source. This source is encoded at the virtualized browser and decoded at the client endpoint. Many modern computing platforms contain specialized processing units that can more efficiently decode this content than general execution instructions. This efficiency offloads processing from the main CPU and lowers power consumption requirements for decoding of the video stream.

Browsers change quickly with rapid technological advancements that can break current web-based applications and often businesses standardize on a single browser so they don't have to test multiple iterations of updated web-based applications on different browsers. The principles provided herein can be augmented against this situation because a virtual web browser can be standardized across all applications or a web browser version can be standardized to a single application. Web-based applications 202 can be paired or standardized on specific virtualized browsers 204 to ensure application compatibility and consistent service, while client connections 228 and client browsers 212 can version independently and are only dependent on the compatibility of the Web-RTC protocol itself, and not the specific application functionality of the web-based applications 202.

Clients 212, including client devices and client browsers, do not see updates to virtual web-based applications. This is an advantage because it allows updates on the virtual server side on a different timetable than the actual server. When a web-based applications breaks, the client connection 228 to the virtual environment is broken and the web-based applications 202 can be restarted because it is not on the same timetable for updates. There is an ability to maintain experiences and state across multiple devices and easily resume sessions.

Performance can also be optimized. If a web-based application performs better on one browser over another browser, the browsers can be swapped for optimal performance. For example, a user may receive a virtual web-based application that is running on Internet Explorer for better performance but the web-based application may appear to the user to be running on Chrome because that is the virtual environment in place.

Also, if the browser gets attacked during use of a virtual web-based application, the virtual web-based application ends but there is no impact on the client. Issues are kept at the virtual environment.

Variations include other technology instead of relying on Web-RTC. For example, the solution may be performed generically, using a JavaScript protocol language or other language. Content may thus be replaced for browsers that do not have web-based technology with virtualization principles discussed herein.

Because of the virtualization principles herein, a better quality of service may be provided to the user. For example, a virtualized web-based application includes a lower latency for providing service than a web-based application requested which makes the redirected output create a more responsive environment. As users move to the web, a more responsive environment is desired. For example, as health care monitoring moves away from a traditional desk type connection, users will want to ensure that the service connection to user is not broken. A virtualized web-based application is a solution that addresses this need. A mechanism is provided to streamline and build efficiency in the quality of service of web-based applications.

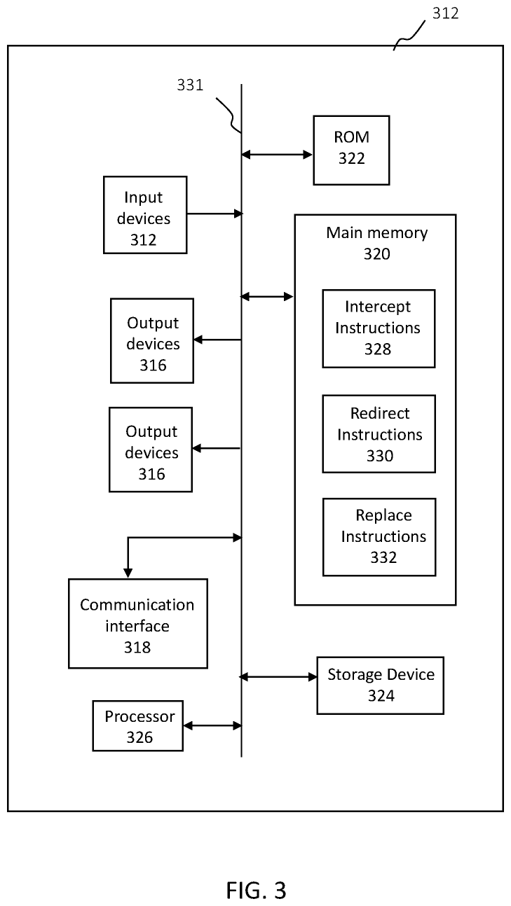

Turning to FIG. 3, an example client 312 is shown according to principles discussed herein. The client 312 may include one or more of a bus 331, processor 326, main memory 320, read only memory (ROM) 322, storage device 324, one or more input devices 312, one or more output devices 316, and a communication interface 318. Bus 331 may include one or more conductors that permit communication among the components of client 312 and server (not shown).

Processor 326 may include any type of conventional processor or microprocessor, or a combination of processors, that interprets and executes machine readable instructions. Main memory 320 may include a random access memory or another type of dynamic storage device that stored information and instructions for execution by processor. As shown, main memory 320 includes intercept instructions (328), when executed by the processor, that cause the processor to intercept a request for a web-based application from a client. Redirect instructions (320), when executed by the processor, cause the processor to redirect the request to a specific application access point maintained by a web generator. Replace instructions (332), when executed by the processor, cause the processor to replace results for the web-based application with redirected output from a virtualized browser at the specific access point by using application code that is separate from the client. For example, the application code may be hosted by and thereby run in the virtualization browser application at the specific access point. Alternatively, the application code may be hosted by and thereby run in another virtualization browser application instance. In this second example, the virtualized browser and the web-generator may not be on the same computer system and may be part of either a physical or virtual host infrastructure in which the virtualized browser is on a distinctly separate environment from the generator itself.

Read only memory (ROM) 322 may include a conventional ROM device or another type of static storage device that stores one or more of static information and machine readable instructions for use by processor. Storage device 324 may include one or more of a magnetic and optical recording medium and its corresponding drive.

Input device 312 may include one or more of conventional mechanisms that permit a user to input information to one or more of client and server, such as a keyboard, mouse, digital pen, touch pad, touch screen, voice recognition, smart card readers, local cameras, local microphones, biometric mechanisms, etc.

Output device 316 may include one or more of conventional mechanisms that output information to the user, including a display, printer, speaker, etc. Communication interface 318 may include any transceiver-like mechanism that enables one or more of client and server to communicate with other devices or systems. For example, the communication interface 318 may include mechanisms for communicating with another device or system via a network, such as network. With this virtualization model, malicious attacks that would otherwise attack a client web-based application can be avoided.

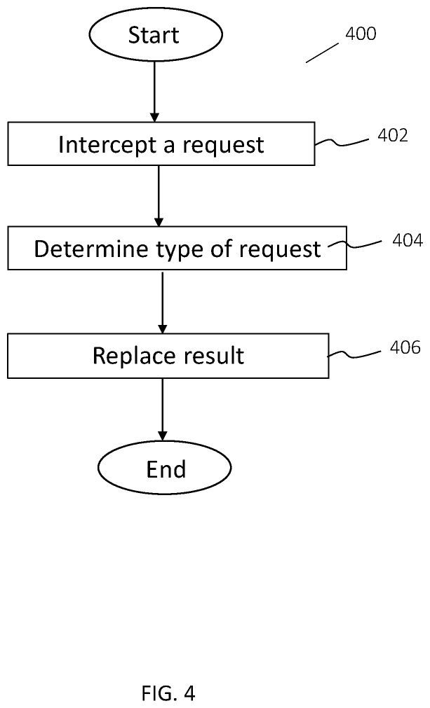

FIG. 4 illustrates a flowchart 400 to implement virtualization of web-based application workloads according to principles discussed herein. In block 402, a request for a web-based application 102 from a client is intercepted by a redirective 106. The redirective 106 determines the type of request being made at block 404. At block 406, the redirective 106 replaces results for the requested web-based application 102 with redirected output including virtualized browsers 104 of the web-based application 102 or content thereof. Requested input may also be redirected to the virtualized browsers of the web-based application 102.

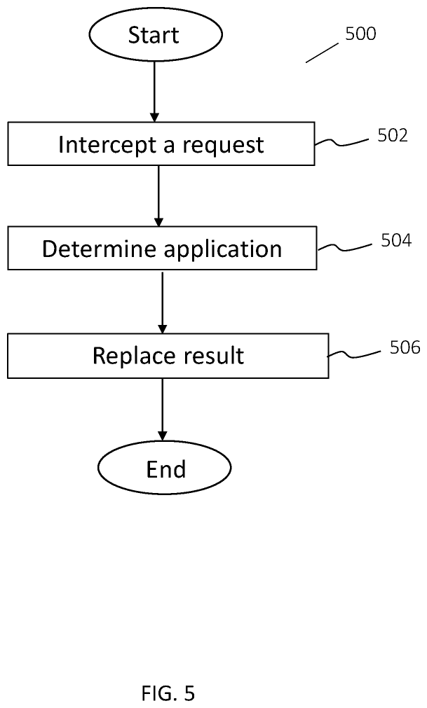

FIG. 5 illustrates a flowchart 500 to implement virtualization of web-based application workloads according to principles discussed herein. In block 502, a request for a web-based application 202 from a client 212 is intercepted by a web generator 206. At block 504, the web generator 206 determines an appropriate virtualized browser 204 that maintains correct application behaviors for the web-based application 202. Based on this determination, at block 506, the web generator 206 replaces results for the web-based application 202 with output from the appropriated virtualized browser 204 using application code not running on the client.

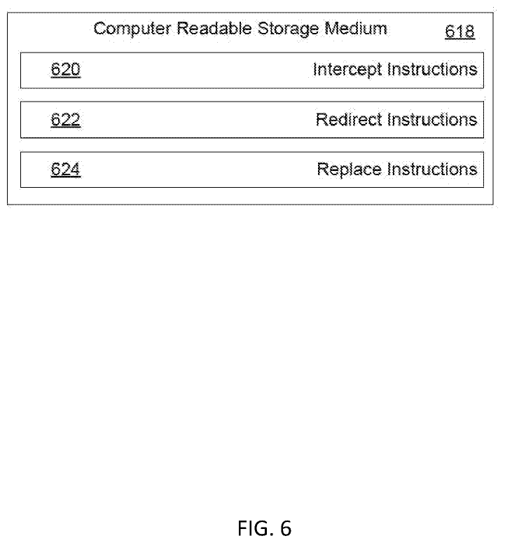

FIG. 6 depicts a non-transitory computer readable storage medium (618), according to an example of the principles described herein. To achieve its desired functionality, a computing system includes various hardware components. Specifically, a computing system includes a processor and a computer readable storage medium (618). The computer readable storage medium (618) is communicatively coupled to the processor. The computer readable storage medium (618) includes a number of instructions (620, 622, 624) for performing a designated function. The computer readable storage medium (618) causes the processor to execute the designated function of the instructions (620, 622, 624). The computer readable storage medium (618) can store data, programs, instructions, or any other machine-readable data. Computer readable storage medium (618) can store computer readable instructions that the processor can process, or execute. The computer readable storage medium (618) can be an electronic, magnetic, optical, or other physical storage device that contains or stores executable instructions. Computer readable storage medium (618) may be, for example, Random Access Memory (RAM), an Electrically Erasable Programmable Read-Only Memory (EEPROM), a storage device, an optical disc, etc. The computer readable storage medium (618) may be a non-transitory machine-readable storage medium (618).

Referring to FIG. 6, intercept instructions (620), when executed by the processor, cause the processor to intercept a request for a web-based application from a client. Redirect instructions (622), when executed by the processor, may cause the processor to, redirect the request to a specific application access point maintained by a web generator. Replace instructions (624), when executed by the processor, may cause the processor to replace results for the web-based application with redirected output from a virtualized browser at the specific access point by using application code not running on the client.

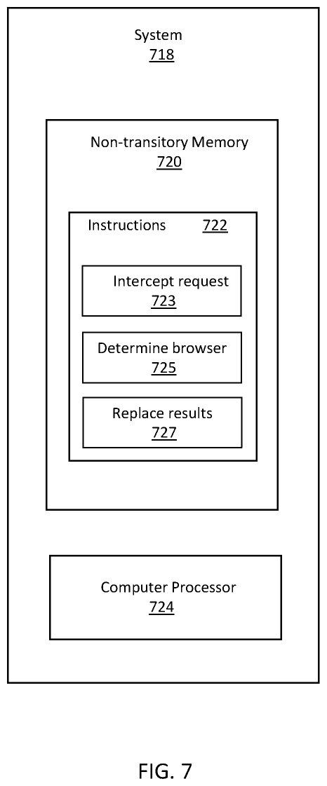

It is also contemplated that principles discussed herein be accomplished through a system. Turning to FIG. 7, a block diagram of a system 718 includes a non-transitory memory 720 that stores instructions 722 and a computer processor 724 that executes the instructions 722 to implement virtualization as discussed herein. Instructions 722 to perform operations include an intercept request 723 for intercepting a request for a web-based application from a client. They further include a determination of the browser 725 for determining an appropriate virtualized browser that maintains correct application behaviors for the web-based application. A replace results 727 instruction replaces results for the web-based application with output from the appropriate virtualized browser using application code that is separate from the client. The application code may further not run on the client.

Examples of systems and mediums may include one or more of standalone devices, machines, networks, etc. This may include the use of one or more of a client, server, control system, network router, switch or bridge, any machine capable of executing a set of instructions that specify actions to be taken by the machine, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of virtualizing web-based application workloads comprising:
intercepting a request for a web-based application from a client;
determining a type of the request for the web-based application;
based on the determining, replacing results with a corresponding redirected output using application code that is separate from the client.

2. The method of claim 1, further comprising determining various subcomponents of the requested web-based application for replacing results.

3. The method of claim 1, wherein direct data and content associated with the request is not redirected in a translatable form from the client.

4. The method of claim 1, further comprising leveraging GPU offload features to render a virtualized browser application and yield performance efficiency.

5. The method of claim 1, further comprising:
providing a web generator that generates and maintains an application access point to the redirected output.

6. The method of claim 1, further comprising sharing resources and efficiencies of a web-application framework including one or more of a rendering engine, JavaScript runtime, and networking libraries.

7. The method of claim 5, wherein the redirected output is presented with an open protocol or through JavaScript extension libraries.

8. The method of claim 1, wherein the requested web-based application and the client remain unchanged.

9. A system for providing virtualized web-based application workloads, comprising:
a non-transitory memory that stores instructions;
a computer processor that executes the instructions to perform operations, the operations comprising:
intercepting a request for a web-based application from a client;
determining an appropriate virtualized browser that maintains correct application behaviors for the web-based application;
based on the determining, replacing results for the web-based applications with application code that is separate from the client.

10. The system of claim 9, wherein the non-transitory memory is stored on an intermediary server or standalone computer device.

11. The system of claim 9, wherein the intermediary server or standalone computer device incorporates Web-RTC to incorporate screen sharing concepts to provide the appropriate redirected output.

12. The system of claim 9, wherein the computer processor comprises
a first logic module to determine an appropriate virtualized browser that maintains correct application behaviors for the web-based application and various subcomponents of the web-based application, and
a second module to replace results for the web-based application with the redirected output from the appropriate virtualized browser using application code that remains separate from the client to maintain security.

13. A non-transitory computer readable medium comprising computer usable program code embodied therewith, the computer usable program code to, when executed by a processor:
intercept a request for a web-based application from a client;
redirect the request to a specific application access point maintained by a web generator;
replace results for the web-based application with redirected output from a virtualized browser at the specific access point by using application code that is not running on the client.

14. The non-transitory computer readable medium of claim 13, further to
use a visual device protocol to incorporate screen sharing concepts to provide the redirected output.

15. The non-transitory computer readable medium of claim 13, wherein the redirected output includes visuals but not data that is scrapable.
